(19) United States
(12) Patent Application Publication
(10) Pub. No.: US 2017/0198141 A1
(43) Pub. Date: Jul. 13, 2017

(54) METHOD FOR PREPARING A POLYMER

(71) Applicant: INDUSTRIAL TECHNOLOGY RESEARCH INSTITUTE, Hsinchu (TW)

(72) Inventors: Po-Hsien HO, Taipei City (TW); Chih-Hsiang LIN, Taipei City (TW); Meng-Hsin CHEN, Xinpi Township (TW); Cheng-Hsing FAN, Tainan City (TW); Hsin-Ching KAO, Baoshan Township (TW); Yih-Her CHANG, Baoshan Township (TW)

(73) Assignee: INDUSTRIAL TECHNOLOGY RESEARCH INSTITUTE, Hsinchu (TW)

(21) Appl. No.: 15/389,711

(22) Filed: Dec. 23, 2016

Related U.S. Application Data
(60) Provisional application No. 62/277,091, filed on Jan. 11, 2016.

(30) Foreign Application Priority Data
Dec. 21, 2016 (TW) 105142423

(51) Int. Cl. C08L 81/02; C08L 33/14; C08G 75/02; C08G 75/04

(52) U.S. Cl. CPC C08L 81/02; C08G 75/04; C08L 33/14; C08G 75/02

(57) ABSTRACT

A method for preparing a polymer is provided. The method for preparing a polymer includes subjecting at least one monomer having a structure represented by Formula (I) to a reaction in the presence of sulfonic acid, diphenyl amine, and oxygen-containing phosphide, obtaining a sulfonium salt polymer

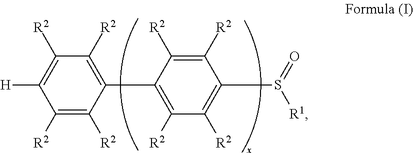

wherein x is 0, 1, or 2, R¹ is C₁₋₆ alkyl group; and R² is independently hydrogen, or C₁₋₆ alkyl group.

### CROSS REFERENCE TO RELATED APPLICATIONS

This application claims the benefit of U.S. Provisional Application No. 62/277,091, filed on Jan. 11, 2016, which is incorporated herein by reference.

The application is based on, and claims priority from, Taiwan Application Serial Number 105142423, filed on Dec. 21, 2016, the disclosure of which is hereby incorporated by reference herein in its entirety.

### TECHNICAL FIELD

The disclosure relates to a method for preparing a polymer, and in particular to a method for preparing a sulfonium salt polymer or polyarylene sulfide (PAS).

### BACKGROUND

Polyarylene sulfide (PAS) is a material with good physical characteristics such as thermal resistance, chemical resistance, flame resistance, and electrical insulation characteristics. Thus, polyarylene sulfide (PAS) can be used in computer accessories and auto accessories; as industrial fibers having chemical resistance; and as a coating for parts that come into contact with corrosive chemicals.

One conventional method for producing polyarylene sulfide (PAS) is the halogen-containing process that, in principle, results in a low yield of polyarylene sulfide (PAS) and produces unrecyclable halogen-containing byproducts that can cause environmental pollution. Since the purification of polyarylene sulfide (PAS) using a conventional method is very difficult, the halogen-containing byproducts reside in the polyarylene sulfide (PAS).

Therefore, a novel method for preparing polyarylene sulfide (PAS) is needed.

### SUMMARY

According to embodiments of the disclosure, the disclosure provides a method for preparing a polymer. The method includes subjecting at least one monomer having a structure represented by Formula (I) to a reaction in the presence of sulfonic acid, diphenyl amine, and oxygen-containing phosphide, obtaining a sulfonium salt polymer

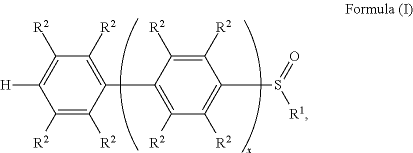

wherein x is 0, 1, or 2; R¹ is C₁₋₆ alkyl; and R² is independently hydrogen, or C₁₋₆ alkyl.

A detailed description is given in the following embodiments with reference to the accompanying drawings.

### DETAILED DESCRIPTION

The conversion rate of the polyarylene sulfide (PAS) is not high when the polyarylene sulfide (PAS) is prepared by polymerizing the monomer (I) under acidic conditions to form the cationic polymer and then subjecting the cationic polymer to a demethylation, referring to Reaction Formula (I).

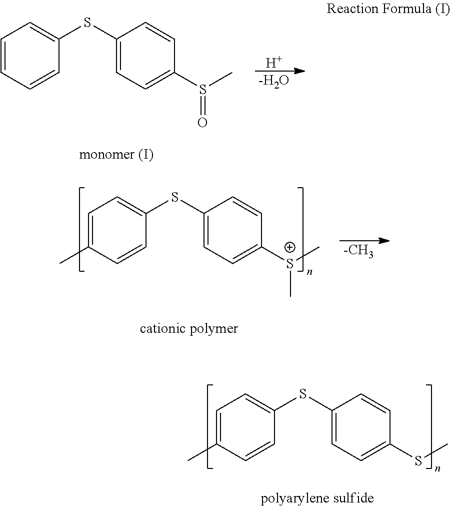

In addition, the monomer (I) may be prepared according to Reaction Formula (II), i.e. a methyl phenyl sulfoxide is reacted with methyl phenyl sulfide under acidic conditions to obtain a cationic intermediate and the cationic intermediate is subjected to a demethylation and oxidation. The yield of the monomer (I), however, is reduced due to the complexity of the preparation as shown in Reaction Formula (II).

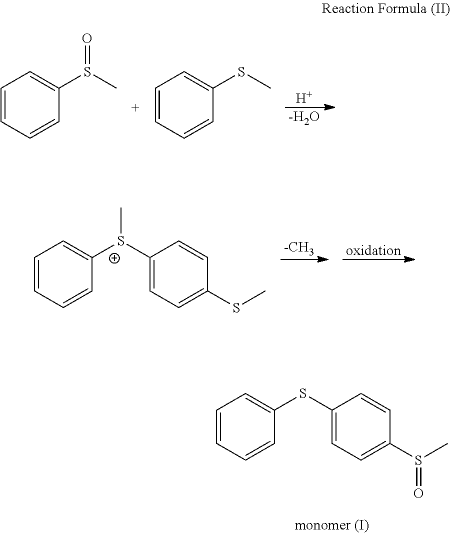

Accordingly, the embodiments of the disclosure provide a method for preparing a polymer in order to increase the availability of the monomer and improve the conversion rate of the monomer to sulfonium salt polymer. According to embodiments of the disclosure, the method includes subjecting at least one monomer having a structure represented by Formula (I) to a polymerization in the presence of sulfonic acid, diphenyl amine, and oxygen-containing phosphide, obtaining a sulfonium salt polymer.

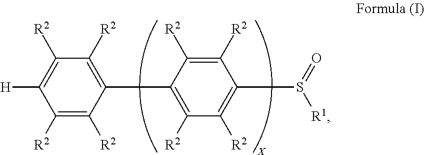

wherein x can be 0, 1, or 2; R¹ can be C₁₋₆ alkyl; and R² can be independently hydrogen, or C₁₋₆ alkyl. According to embodiments of the disclosure, the sulfoxide functional group (S═O) of the monomer having a structure represented by Formula (I) can be protonated under acidic conditions to form a reactive sulfonium hydroxide. Furthermore, the diphenylamine, serving as charge control agent, can provide an electron to complex with to the sulfonium hydroxide to form a complex structure, thereby enhancing the reactivity of the i-electrons of the aromatic ring for polymerization. The conversion rate of the monomer having a structure represented by Formula (I) to the sulfonium salt polymer (or polyarylene sulfide) can be significantly increased when the polymerization is performed in the presence of the oxygen-containing phosphide. In addition, after obtaining the sulfonium salt polymer, a nucleophile can be reacted with the sulfonium salt polymer, obtaining a thermal resistant polyarylene sulfide (having a melting temperature (Tm) larger than or equal to 280° C.) without being mixed with halogen-containing byproduct. According to embodiments of the disclosure, the conversion rate of the monomer having a structure represented by Formula (I) to the sulfonium salt polymer (or polyarylene sulfide) was determined by the following equation:

$$conversion rate = \frac{weight of monomer}{\begin{matrix}weight of sulfonium salt polymer \\ ( or polyarylene sulfide )\end{matrix} } \times 100 \%$$

According to embodiments of the disclosure, the alkyl group of the disclosure can be a linear or branched alkyl group. Therefore, R¹ can be methyl, ethyl, propyl, isopropyl, n-butyl, t-butyl, sec-butyl, isobutyl, pentyl, or hexyl. In addition, each R² can be independently hydrogen, fluorine, methyl, ethyl, propyl, isopropyl, n-butyl, t-butyl, sec-butyl, isobutyl, pentyl, or hexyl.

According to embodiments of the disclosure, the sulfonic acid can be a compound having a structure represented by Formula (II)

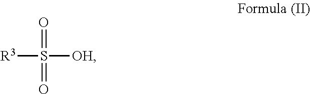

C₁₋₆ alkyl group, or C₁₋₆ fluoroalkyl group. Herein, the haloalkyl group means that hydrogen atoms bonded on carbon atoms of linear or branched alkyl group can be partially or totally replaced with fluorine. For Example, fluoromethyl can be —CH₂F, —CHF₂— or —CF₃. According to embodiments of the disclosure, R³ can be methyl, ethyl, propyl, isopropyl, n-butyl, t-butyl, sec-butyl, isobutyl, pentyl, hexyl, fluoromethyl, fluoroethyl, or fluoropropyl. According to some embodiments of the disclosure, the sulfonic acid can be methanesulfonic acid, ethanesulfonic acid, propylsulfonic acid, trifluoromethanesulfonic acid (CF₃SO₃H), or a combination thereof. According to embodiments of the disclosure, the molar ratio of the sulfonic acid to the monomer can be from about 1 to 200, such as from about 1 to 100. Herein, the sulfonic acid can provide acidic conditions in order to promote the polymerization of the monomer, and the excessive sulfonic acid can also serve as the reaction solvent.

According to embodiments of the disclosure, due to the oxygen-containing phosphide used in the method for preparing a polymer of the disclosure, the conversion rate of the monomer having a structure represented by Formula (I) to the sulfonium salt polymer can be significantly increased. The oxygen-containing phosphide can be a compound consisting of oxygen and phosphorus, such as phosphoric anhydride (P₂O₅). In addition, the oxygen-containing phosphide can be a compound consisting of oxygen, hydrogen and phosphorus, such as polyphosphoric acid (H₍ₙ₊₂₎PnO₍₃ₙ₊₁₎, wherein n is larger than 1). According to embodiments of the disclosure, the molar ratio of the oxygen-containing phosphide to the monomer can be from about 0.5 to 2, such as from about 0.5 to 1.5.

According to embodiments of the disclosure, the molar ratio of the diphenylamine to the monomer can be from about 0.5 to 2, such as from about 0.5 to 1.5. The diphenylamine and oxygen-containing phosphide can enhance the polymerization of the monomer having a structure represented by Formula (I), and the diphenylamine and oxygen-containing phosphide are not reactants of the polymerization.

According to embodiments of the disclosure, the method for preparing a polymer of the disclosure can include subjecting one monomer having a structure represented by Formula (I) to a polymerization in the presence of sulfonic acid, diphenylamine, and oxygen-containing phosphide, wherein the monomer having a structure represented Formula (I) can be

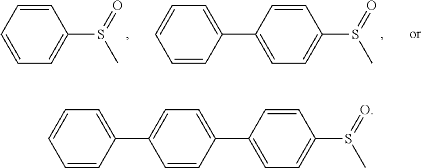

In addition, according to embodiments of the disclosure, the method for preparing a polymer of the disclosure can include subjecting two different monomers having a structure represented by Formula (I) to a polymerization in the presence of sulfonic acid, diphenylamine, and oxygen-containing phosphide, wherein one of the two different monomers can be

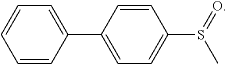

Moreover, according to embodiments of the disclosure, the method for preparing a polymer of the disclosure can include subjecting two different monomers having a structure represented by Formula (I) to a polymerization in the presence of sulfonic acid, diphenylamine, and oxygen-containing phosphide, wherein the two different monomers having a structure represented by Formula (I) can be

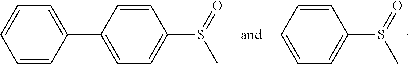

According to embodiments of the disclosure, the sulfonium salt polymer prepared by the aforementioned method for preparing a polymer of the disclosure can include at least one repeating unit having a structure represented by Formula (III),

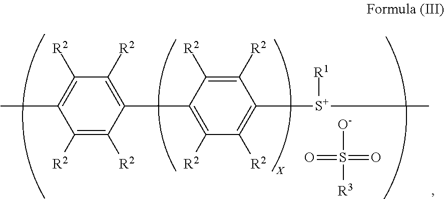

wherein x can 0, 1, or 2; R¹ can be C₁₋₆ alkyl group; each R² can be independently hydrogen, or C₁₋₆ alkyl group; and, R³ can be hydrogen, C₁₋₆ alkyl group, or C₁₋₆ haloalkyl group. According to some embodiments of the disclosure, the repeating unit having a structure represented by Formula (III) can be

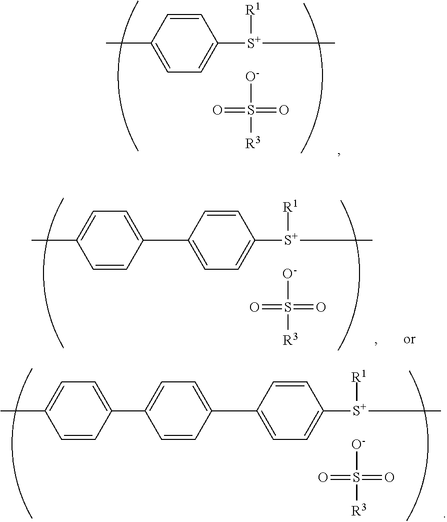

According to embodiments of the disclosure, after obtaining the sulfonium salt polymer, the method for preparing a polymer can further include reacting a nucleophile with the sulfonium salt polymer, obtaining a polyarylene sulfide. In particular, the nucleophile can be substituted or unsubstituted pyridine or derivatives thereof (such as pyridine or 4-methylpyridine), amine (such as triethylamine), halogenated salt (such as potassium chloride), alcohol (such as methanol or ethanol), or amide (such as dimethylformamide, dimethylacetamide, or N-methylpyrrolidone). The molar ratio of the nucleophile to the monomer having a structure represented by Formula (I) (for forming the sulfonium salt polymer) can be from about 1 to 100, and the excessive nucleophile can also serve as the reaction solvent. The polyarylene sulfide (PAS) can have at least one repeating unit having a structure represented by Formula (IV)

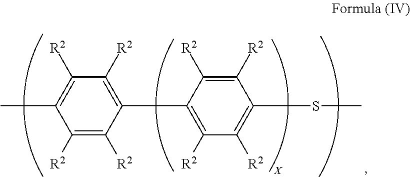

wherein x can be 0, 1, or 2; and, each R² can be hydrogen, or C₁₋₆ alkyl group. The repeating unit having a structure represented by Formula (IV) can be

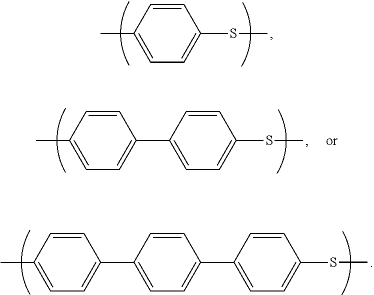

The inventive concept of the disclosure may be embodied in various forms without being limited to the exemplary embodiments set forth herein.

### EXAMPLE 1

0.5 g of methyl phenyl sulfoxide, 0.25 g of phosphorus pentoxide (P₂O₅), and 0.3 g of diphenyl amine were added into a reaction bottle. Next, 3 ml of trifluoromethanesulfonic acid was added slowly into the reaction bottle at 0□ (ice bath). After stirring for 1 hr, the reaction bottle was raised back to room temperature. After stirring for 20 hr, the result was poured into 100 ml of ethyl ether. After stirring, the result was washed with a small amount of acetone. After drying, Sulfonium salt polymer (I) (white solid) was obtained.

Next, Sulfonium salt polymer (I) was dissolved in 15 ml of 4-methylpyridine, and the obtained solution was heated to reflux (about 100° C.). After stirring for 6 hr, the result was poured into 30 ml of hydrochloric acid aqueous solution (with a concentration of 10%), and then washed with a small amount of acetone, obtaining Polyarylene sulfide (PAS) (I) (white solid) with a conversion rate about 88%. The synthesis pathway of the above reaction was as follows:

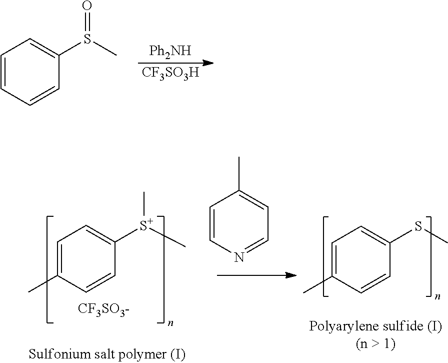

Next, the properties of Polyarylene sulfide (PAS) (I) were measured by a differential scanning calorimetry (DSC), and the result shows that Polyarylene sulfide (PAS) (I) has a melting temperature (Tm) of about 281° C. and a recrystallization temperature (Tc) of about 210° C. Next, Polyarylene sulfide (PAS) (I) was analyzed by Fourier-transform infrared (FT-IR) spectroscopy, and the result shows that the strong absorption peaks (cm⁻¹) are 3065, 1573, 1471, 1387, 1092, 1009, 998, 815, 742.

### EXAMPLE 2

3 g of phenylboronic acid, 3.45 g of 4-bromothioanisole, 0.1 g of Pd(PPh₃)₄, and 1.5 g of sodium carbonate (Na₂CO₃) were added into a reaction bottle. Next, 50 ml of toluene, 60 ml of deionized water, and 10 ml of methanol were added slowly into the reaction bottle. After stirring for 24 hr at 100° C., ethyl acetate was utilized to extract the solution with water several times, and then the organic phase was collected. After drying, Compound (I) (1-methylsulfanyl-4-phenylbenzene) with a yield of about 99% was obtained. The synthesis pathway of the above reaction was as follows:

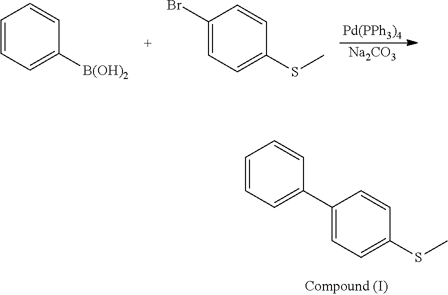

Compound (I) was analyzed by nuclear magnetic resonance (NMR) spectroscopy and the result is as follows: ¹H NMR (500 MHz, ppm, CDCl₃): 2.55 (—CH3, s), 7.33-7.37 (phenyl, 3H, m), 7.43-7.45 (phenyl, 2H, m), 7.54-7.6 (phenyl, 4H, m).

Next, 1 g of compound (I) was added into a reaction bottle, and then 10 ml of acetic acid and 2 ml of hydrogen peroxide (with a concentration of 30%) were added slowly into the reaction bottle. After stirring at room temperature for 20 min, the result was filtered, obtaining an orange solid. The orange solid was extracted three times using dichloromethane and water as the extraction solvent, and then the organic phase was collected. After drying, filtering and concentrating the organic phase, Compound (II) was obtained. The synthesis pathway of the above reaction was as follows:

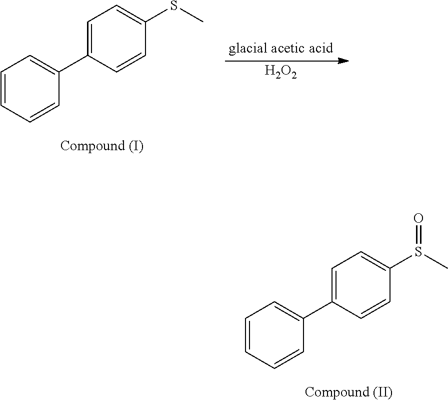

Compound (II) was analyzed by nuclear magnetic resonance (NMR) spectroscopy and the result is as follows: ¹H NMR (500 MHz, ppm, CDCl₃): 2.80 (—CH₃, s), 7.42-7.51 (biphenyl, 3H, m), 7.62-7.63 (biphenyl, 2H, m), 7.73-7.78 (biphenyl, 4H, m).

Next, 0.5 g of compound (II), 0.39 g of diphenyl amine, and 0.16 g of phosphorus pentoxide (P₂O₅) were added into a reaction bottle. Next, 5 ml of trifluoromethanesulfonic acid was added into the reaction bottle at 0° C. (ice bath). After stirring at 0° C. (ice bath) for 1 hr, the reaction bottle was raised slowly back to room temperature. After stirring for 20 hr, the result was poured into 100 ml of ethyl ether, and then washed with a small amount of acetone. After drying, Sulfonium salt polymer (II) was obtained. Next, Sulfonium salt polymer (II) was dissolved in 6 ml of 4-methylpyridine, and then stirred at room temperature for 1 hr. Next, the result was heated to reflux (about 120° C.). After stirring for 20 hr, the result was poured into 30 ml of hydrochloric acid aqueous solution (with a concentration of 10%), and then washed with a small amount of acetone, obtaining Polyarylene sulfide (PAS) (II) (white solid) with a conversion rate of about 90%, as shown in Table 1. The synthesis pathway of the above reaction was as follows:

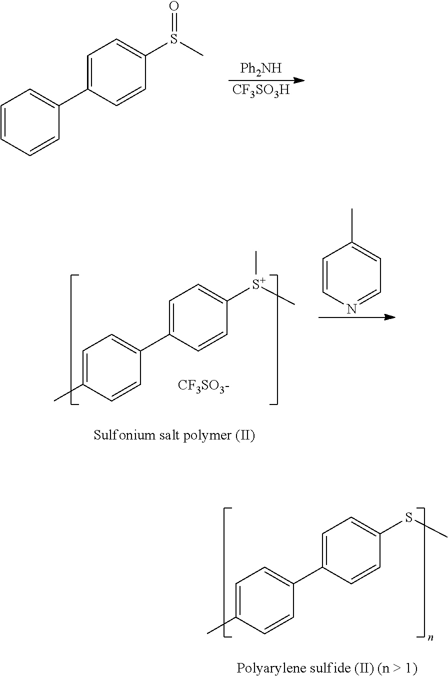

Next, the properties of Polyarylene sulfide (PAS) (II) were measured by a differential scanning calorimetry (DSC), and the result shows that Polyarylene sulfide (PAS) (II) has a melting temperature (Tm) of about 404° C. and a recrystallization temperature (Tc) of about 369° C. Next, Polyarylene sulfide (PAS) (II) was analyzed by Fourier-transform infrared (FT-IR) spectroscopy, and the result shows that the strong absorption peaks (cm⁻¹) are 3026, 1590, 1474, 1391, 1313, 1152, 1137, 1090, 1045, 998, 952, 811, 758, 690.

### COMPARATIVE EXAMPLE 1

0.5 g of compound (II) and 0.39 g of diphenylamine were added into a reaction bottle. Next, 5 ml of trifluoromethanesulfonic acid was added into the reaction bottle and cooled to 0□ (ice bath). After stirring at 0□ (ice bath) for 1 hr, the reaction bottle was raised slowly back to room temperature. Next, after stirring for 20 hr, the result was poured into 100 ml of ethyl ether, and washed with a small amount of acetone. After drying, Sulfonium salt polymer (II) was obtained. Next, Sulfonium salt polymer (II) was dissolved in 6 ml of 4-methylpyridine and stirred at room temperature for 1 hr. Next, the result was heated to reflux (about 120° C.). After stirring for 20 hr, the result was poured into 30 ml of hydrochloric acid aqueous solution (with a concentration of 10%), and washed with a small amount of acetone, obtaining Polyarylene sulfide (PAS) (II) (white solid) with a conversion rate of about 57%, as shown in Table 1.

TABLE 1

| | compound | trifluoromethanesulfonic | | phosphorus | conversion |
|---|---|---|---|---|---|
| | (II) | acid | diphenylamine | pentoxide | rate |
| Example 2 | 0.5 g | 5 ml | 0.39 g | 0.33 g | 90% |
| Comparative | 0.5 g | 5 ml | 0.39 g | — | 57% |
| Example 1 | | | | | |

In comparison with Comparative Example 1, besides trifluoromethanesulfonic acid and diphenylamine, Example 2 further employed phosphorus pentoxide during the polymerization of Compound (II). As shown in Table 1, in comparison with Comparative Example 1, Polyarylene sulfide (PAS) (II) prepared by Example 2 exhibits a relatively high conversion rate.

### EXAMPLE 3

0.19 g of methyl phenyl sulfoxide, 0.3 g of compound (II), 0.2 g of phosphorus pentoxide, and 0.23 g of diphenylamine were added into a reaction bottle. Next, 3 ml of trifluoromethanesulfonic acid was added at 0° C. (ice bath). After stirring at 0□ (ice bath) for 1 hr, the reaction bottle was raised slowly back to room temperature. After stirring for 20 hr, the result was poured into 100 ml of ethyl ether, and then washed with a small amount of acetone. After drying, Sulfonium salt polymer (III) was obtained. Next, Sulfonium salt polymer (III) was dissolved in 15 ml of 4-methylpyridine, and then stirred at room temperature for 1 hr. Next, the result was heated to reflux (about 100° C.). After stirring for 6 hr, the result was poured into 30 ml of hydrochloric acid aqueous solution (with a concentration of 10%), and then washed with a small amount of acetone, obtaining Polyarylene sulfide (PAS) (III) (white solid) with a conversion rate of about 35%, as shown in Table 2. The synthesis pathway of the above reaction was as follows:

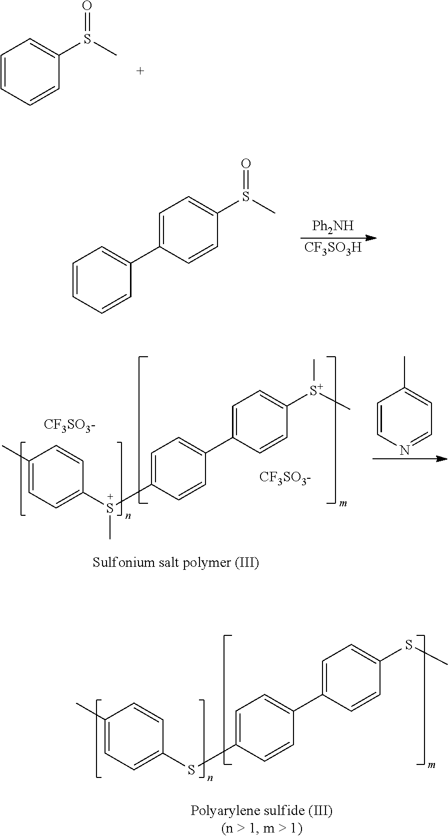

(the repeating units of the Sulfonium salt polymer (III) or Polyarylene sulfide (PAS) (III) are arranged in a random fashion).

Next, the properties of Polyarylene sulfide (PAS) (III) were measured by a differential scanning calorimetry (DSC), and the result shows that Polyarylene sulfide (PAS) (III) has a glass transition temperature (Tg) of about 113° C. Next, Polyarylene sulfide (PAS) (III) was analyzed by Fourier-transform infrared (FT-IR) spectroscopy, and the result shows that the strong absorption peaks are 3024, 1584, 1474, 1389, 1319,1178, 1155, 1090, 1001, 810, 759, 694.

### COMPARATIVE EXAMPLE 2

Comparative Example 2 was performed in the same manner as in Example 3 except that phosphorus pentoxide was absent during the polymerization, obtaining polyarylene sulfide (PAS) (III) with a conversion rate about <5%, as shown in Table 2.

TABLE 2

| | compound | trifluoromethanesulfonic | | phosphorus | conversion |
|---|---|---|---|---|---|
| | (II) | acid | diphenylamine | pentoxide | rate |
| Example 3 | 0.3 g | 3 ml | 0.23 g | 0.2 g | 35% |
| Comparative | 0.3 g | 3 ml | 0.23 g | — | ≦5% |
| Example 2 | | | | | |

In comparison with Comparative Example 2, besides trifluoromethanesulfonic acid and diphenylamine, Example 3 further employed phosphorus pentoxide during the polymerization of Compound (II) and methyl phenyl sulfoxide. As shown in Table 2, in comparison with Comparative Example 2, Polyarylene sulfide (PAS) (III) prepared by Example 3 exhibits a relatively high conversion rate.

It will be clear that various modifications and variations can be made to the disclosed methods and materials. It is intended that the specification and examples be considered as exemplary only, with the true scope of the disclosure being indicated by the following claims and their equivalents.

1. A method for preparing a polymer, comprising:
subjecting at least one monomer having a structure represented by Formula (I) to a reaction in the presence of sulfonic acid, diphenyl amine, and oxygen-containing phosphide, obtaining a sulfonium salt polymer 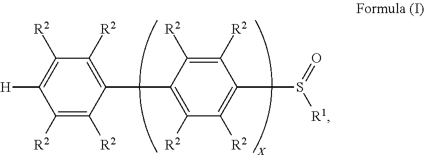
wherein x is 0, 1, or 2; R¹ is C₁₋₆ alkyl group; and R² is independently hydrogen, or C₁₋₆ alkyl group.

2. The method as claimed in claim 1, wherein R¹ is methyl, ethyl, propyl, isopropyl, n-butyl, t-butyl, sec-butyl, isobutyl, pentyl, or hexyl.

3. The method as claimed in claim 1, wherein R² is hydrogen, methyl, ethyl, propyl, isopropyl, n-butyl, t-butyl, sec-butyl, isobutyl, pentyl, or hexyl.

4. The method as claimed in claim 1, wherein the sulfonic acid is a compound having a structure represented by Formula (II) 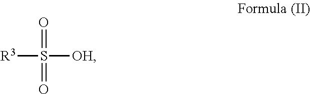
wherein R³ is hydrogen, C₁₋₆ alkyl group, or C₁₋₆ fluoroalkyl group.

5. The method as claimed in claim 1, wherein the sulfonic acid is methanesulfonic acid, ethanesulfonic acid, propylsulfonic acid, trifluoromethanesulfonic acid, or a combination thereof.

6. The method as claimed in claim 1, wherein the oxygen-containing phosphide is phosphoric anhydride, polyphosphoric acid, or a combination thereof.

7. The method as claimed in claim 1, wherein the monomer having a structure represented by Formula (I) is

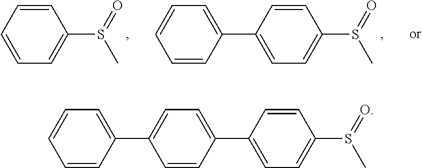

8. The method as claimed in claim 1, wherein the at least one monomer having a structure represented by Formula (I) is

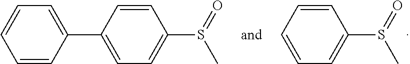

9. The method as claimed in claim 4, wherein the sulfonium salt polymer has at least one repeating unit having a structure represented by Formula (III) 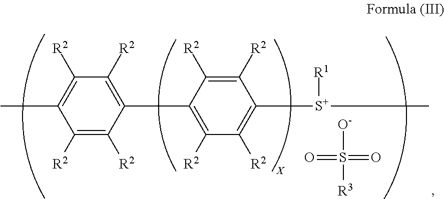
wherein x is 0, 1, or 2; R¹ is C₁₋₆ alkyl group; R² is independently hydrogen, or C₁₋₆ alkyl group; and, R³ is hydrogen, C₁₋₆ alkyl group, or C₁₋₆ fluoroalkyl group.

10. The method as claimed in claim 9, wherein the repeating unit having a structure represented by Formula (III) is

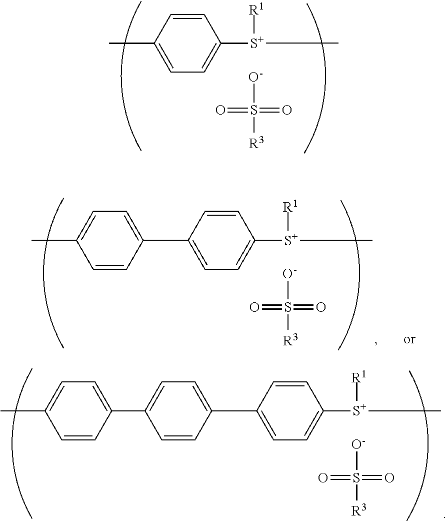

11. The method as claimed in claim 1, further comprising:
reacting a nucleophile with the sulfonium salt polymer, obtaining a polyarylene sulfide.

12. The method as claimed in claim 11, wherein the nucleophile is pyridine, 4-methylpyridine, triethylamine, potassium chloride, methanol, ethanol, dimethylformamide, dimethylacetamide, N-methylpyrrolidone, or a combination thereof.

13. The method as claimed in claim 11, wherein the polyarylene sulfide (PAS) has at least one repeating unit having a structure represented by Formula (IV) 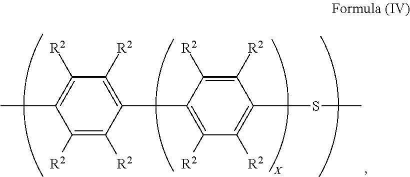
wherein x is 0, 1, or 2; and R² is independently hydrogen, or C₁₋₆ alkyl group.

14. The method as claimed in claim 13, wherein the repeating unit having a structure represented by Formula (IV) is [chemical structure]
